(19) United States
(12) Patent Application Publication
(10) Pub. No.: US 2010/0123740 A1
(43) Pub. Date: May 20, 2010

(54) DISPLAY ADJUSTING CIRCUIT FOR ORGANIC ELECTROLUMINESCENCE PANEL, DISPLAY ADJUSTING CIRCUIT, AND DISPLAY DEVICE

(75) Inventors: Yasuo Inoue, Tokyo (JP); Masahiro Ito, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SONY CORPORATION, Tokyo (JP)

(21) Appl. No.: 12/532,843

(22) PCT Filed: Apr. 24, 2008
(86) PCT No.: PCT/JP2008/057946

§ 371 Date: Sep. 24, 2009

(30) Foreign Application Priority Data
Apr. 26, 2007 (JP) 2007-116326

(51) Int. Cl. G09G 5/10; G09G 3/30

(52) U.S. Cl. 345/690; 345/77

(57) ABSTRACT

There is provided a display adjusting circuit for performing adjustment for display on a video signal to be supplied to an organic electroluminescence panel, the display adjusting circuit of the organic electroluminescence panel, comprising a linear gamma circuit where a video signal on which a predetermined gamma adjustment has been performed is supplied to be converted into a video signal with a linear gamma characteristic by cancelling the gamma adjustment of the supplied video signal and to be output, an adjusting circuit to which the video signal output from the linear gamma circuit is supplied, and a panel gamma circuit where the video signal output from the adjusting circuit is supplied to be converted into a video signal with a gamma characteristic corresponding to a gamma characteristic of the organic electroluminescence panel and to be output, the adjusting circuit including a detecting unit for detecting a driving state or a driving history of the organic electroluminescence panel from the supplied video signal, an adjusting unit for performing adjustment on the video signal supplied to the organic electroluminescence panel by a detecting output of the detecting unit.

### TECHNICAL FIELD

The present invention relates to a display adjusting circuit for an organic electroluminescence panel, a display adjusting circuit, and a display device.

### BACKGROUND ART

For a display device in the shape of a panel, an organic electroluminescence (OLED) panel is used. This organic electroluminescence panel has a plurality of organic electroluminescence elements arranged in a matrix pattern, and one of the organic electroluminescence elements corresponds to one pixel (a pixel for any of red, green, and blue).

FIG. 7 shows, in principle, a driving circuit for one organic electroluminescence element, where a transistor (TFT) Q for driving and an organic electroluminescence element D are connected in series to a power source +VDD and a signal voltage V of a video signal is supplied to the transistor Q.

Therefore, because the signal voltage V is converted into a signal current I by the transistor Q and this signal current I flows through the organic electroluminescence element D, light L at the luminance (light intensity) corresponding to the magnitude of the signal current I is output from the organic electroluminescence element D, and as a result, a pixel at the luminance corresponding to the signal voltage V is displayed.

Thus, in a display device using a organic electroluminescence panel, an organic electroluminescence element D itself emits light, so that a backlight like a liquid-crystal display device is unnecessary and making thinner is possible. Also, because its light-emitting is caused by excitons within an organic semiconductor, the efficiency of energy conversion is high, and the necessary voltage for light-emitting itself can be lowered to about a few volts.

Moreover, the response speed is fast, the viewing angle is wide, and also colour reproducing range is wide. Also, the magnetism will not have any effect, as in a Braun Tube (a receiving tube). Besides, the organic electroluminescence is also called as an organic LED, OLED, etc.

Also, prior art documents include the following one, for example.

[Patent Document] JP 2005-300929 (A)

### DISCLOSURE OF THE INVENTION

### Object to be Achieved by the Invention

Now, in a display device using an organic electroluminescence panel, in order to reproduce an image in high definition, various adjustments are necessary for video signals. In the Patent Document 1, there is described a display device, in which a current detecting means is provided for an organic electroluminescence panel, and in which degradation of luminance due to temporal changes and the like is compensated by adjusting a potential difference in accordance with a detected current.

However, in a organic electroluminescence panel, various adjustments may be necessary for managing temporal changes in white balance and colour temperature, protecting from an overflowed current, and preventing and reducing sticking, for example, and in such a case, it is demanded to more simply and precisely detect the driving state of the organic electroluminescence panel, and perform adjustments and controls.

The present invention enables detecting more simply and precisely the driving state of an organic electroluminescence panel and performing various adjustments and controls in order to keep a better display on a display device using the organic electroluminescence panel.

### Solution for Achieving the Problems

With the present invention, there is provided

a display adjusting circuit for performing adjustment for display on a video signal to be supplied to an organic electroluminescence panel, the display adjusting circuit of the organic electroluminescence panel, including

a linear gamma circuit where a video signal on which a predetermined gamma adjustment has been performed is supplied to be converted into a video signal with a linear gamma characteristic by cancelling the gamma adjustment of the supplied video signal and to be output,

an adjusting circuit to which the video signal output from the linear gamma circuit is supplied, and

a panel gamma circuit where the video signal output from the adjusting circuit is supplied to be converted into a video signal with a gamma characteristic corresponding to a gamma characteristic of the organic electroluminescence panel and to be output,

the adjusting circuit including

a detecting unit for detecting a driving state or a driving history of the organic electroluminescence panel from the supplied video signal,

an adjusting unit for performing adjustment on the video signal supplied to the organic electroluminescence panel by a detecting output of the detecting unit.

In a display adjusting circuit according the present invention, the gamma characteristic of an input signal is converted into a video signal with a linear input/output characteristic, the driving state of the organic electroluminescence panel is detected based on signal information with the input/output characteristic converted into linear, and a video signal to be output is adjusted by use of the detecting result

Therefore, a value of the signal information with the input/output characteristic converted into linear corresponds to a light output of an element of the organic electroluminescence panel, namely the driving state of the element.

### ADVANTAGE OF THE INVENTION

According to the invention, because a driving state or a driving history of the organic electroluminescence panel can be detected readily from the signal information with the input/output characteristic converted into linear, a proper adjustment on a video signal is performed by relatively small sized circuitry configuration by use of the detection result, and an image display in high definition can be held on the organic electroluminescence panel.

### BRIEF DESCRIPTION OF THE DRAWINGS

FIG. 1 is a system diagram according to an embodiment of the present invention.

FIG. 2A is an illustration that shows an example of a schematic configuration of a display device according to an embodiment of the present invention.

FIG. 2B is an illustration that shows an example of a pixel circuit of the display device according to an embodiment of the present invention.

FIG. 3 is an illustration that shows an example of the cross-sectional configuration of the main part in the display area of the display device shown in FIG. 2A.

FIG. 4 is a characteristic diagram for explaining the operation of the circuit in FIG. 1.

FIG. 5 is a characteristic diagram for explaining the operation of the circuit in FIG. 1.

FIG. 6 is a characteristic diagram for explaining the operation of the circuit in FIG. 1.

FIG. 7 is a connection diagram for explaining the characteristic of an organic electroluminescence element.

FIG. 8 is a characteristic diagram for explaining the operation of the element in FIG. 7.

### EXPLANATION OF REFERENCE NUMERALS

1 signal source
10 display adjusting circuit
11 orbit circuit
12 linear gamma circuit
13 panel gamma circuit
14 dither circuit
15 output converting circuit
20 adjusting circuit
21 pattern generator
22 colour temperature adjusting circuit
23 long-term white balance adjusting circuit
24 ABL circuit
25 partial sticking adjusting circuit
26 luminescence unevenness adjusting circuit
32 communication circuit
33 still image detecting circuit
34 white balance detecting circuit
35 average luminance detecting circuit
36 gate pulse circuit
42 organic electroluminescence panel
43 current detecting circuit
51 micro computer for control
52 non volatile memory
100 display device

### BEST MODE FOR CARRYING OUT THE INVENTION

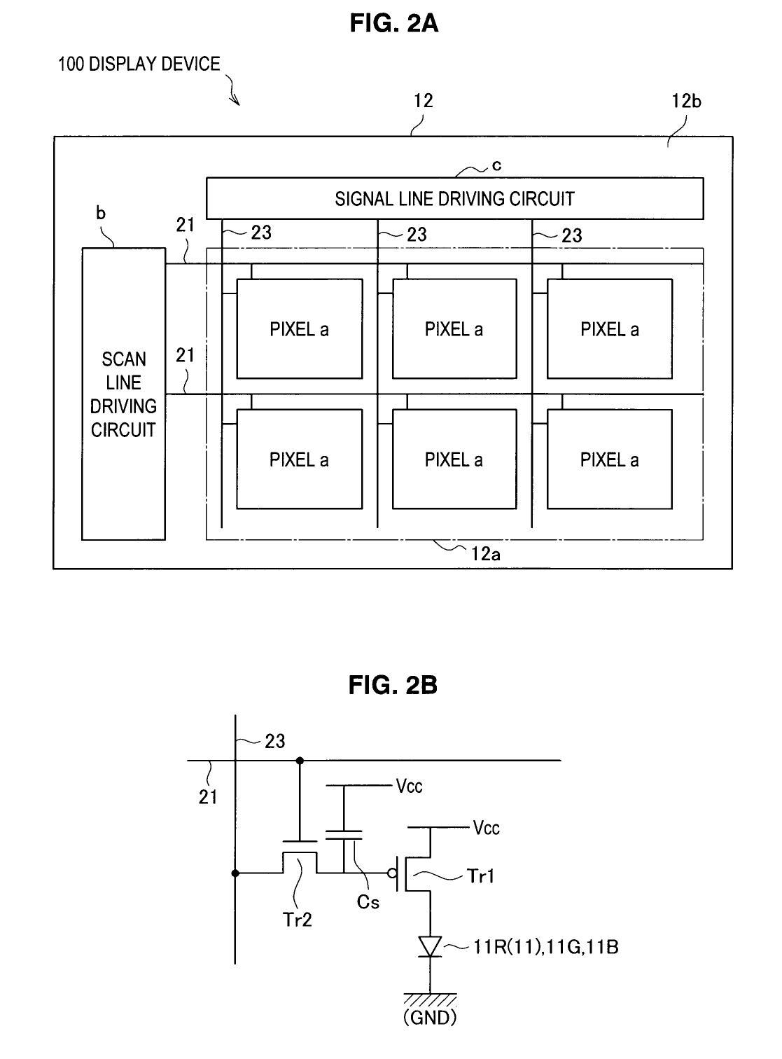

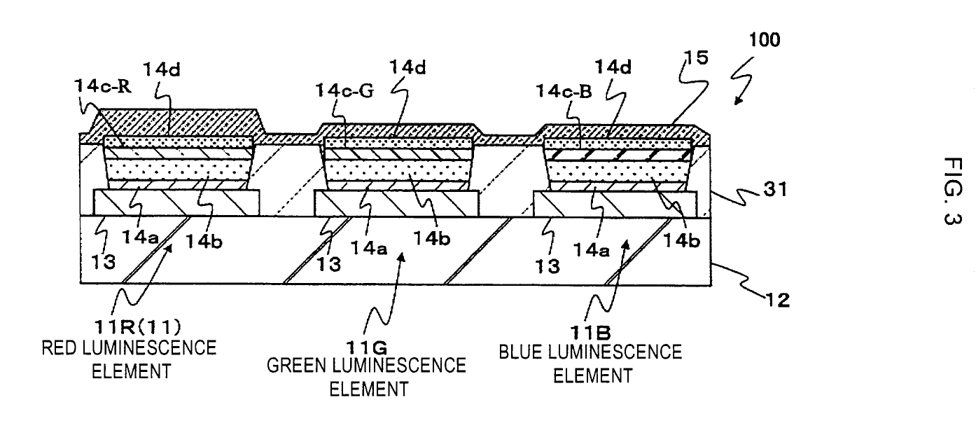

FIG. 2 is an illustration that shows an example of a schematic configuration of a display device 100 according to an embodiment of the present invention, and FIG. 2B is an illustration that shows an example of a pixel circuit of the display device 100 according to an embodiment of the present invention. Also, FIG. 3 is an illustration that shows an example of the cross-sectional configuration of the main part in the display area of the display device 100 shown in FIG. 2A. Here will be described an embodiment in which the present invention is applied to the display device 100 in active matrix mode using organic electroluminescence elements 11 for luminescence elements.

As shown in FIG. 2A, on a substrate 12 of the display device 100, there are designed a display area 12a and its surrounding area 12b. The display area 12a has a plurality of scan lines 21 and a plurality of signal lines 23 arranged longitudinally and transversely, and configured as a pixel array in which one pixel a is provided in correspondence to each cross. One of organic electroluminescence elements 11R (11), 11G, 11B shown in FIG. 3 is provided for each of these pixels a. Also in the surrounding area 12b, there are arranged a scan line driving circuit b for scan-driving the scan lines 21, and a signal line driving circuit c for supplying signal lines 23 with video signals (i.e., input signals) according to luminance information.

As shown in FIG. 2B, the pixel circuit provided for each pixel a is configured with one of each of the organic electroluminescence elements 11R (11) (red luminescence element), 11G (green luminescence element), and 11B (blue luminescence element), a driving transistor Tr1, a writing transistor (sampling transistor) Tr2, and a hold capacitance Cs. Then by driving by the scan line driving circuit b, a video signal that has been written from a signal line 23 via the writing transistor (sampling transistor) Tr2 is held at the hold capacitance Cs, a current depending on the held signal amount is supplied to each organic electroluminescence element 11R (11), 11G, or 11B, and the organic electroluminescence elements 11R (11), 11G, and 11B emit light at the luminance depending on this current value.

Besides, the above configuration of the pixel circuit is just one example after all, and as necessary, a capacitance element may be provided within the pixel circuit, or a further plurality of transistors may be provided to configure the pixel circuit. Also, in the surrounding area 2b, a necessary driving circuit is added according to changes in the pixel circuit.

### <Cross-Sectional Configuration Example of Organic Electroluminescence Panel>

Next, with reference to FIG. 3, the cross-sectional configuration of the main part in the display area of the display device 100 will be described.

In the display area of the substrate 12, where the organic electroluminescence elements 11R (11), 11G, and 11B are provided, the driving transistors, the writing transistors, the scan lines, and the signal lines are provided to configure the above-mentioned pixel circuit (see FIG. 2), and a dielectric film is provided to cover these, though their depictions are omitted here.

On the substrate 12 covered with this dielectric film, the organic electroluminescence elements 11R (11), 11G, and 11B are arrayed. Each of the organic luminescence elements 11R (11), 11G, and 11B is configured as a top surface luminescence type element by which light is obtained from the opposite side of the substrate 12.

An anode 13 of each of the electroluminescence elements 11R (11), 11G, and 11B is patterned for each element. Each anode 13 is connected to the driving transistor of the pixel circuit via a connecting through-hole formed in the dielectric film which covers the surface of the substrate 12.

Each anode 13 has its peripheral part covered with the dielectric film 31, and the centre parts of the anodes 13 are exposed by the opening parts provided in the dielectric film 31. Then, in the configuration, organic layers 14 are patterned, covering the exposed parts of the anodes 13, and a cathode 15 is provided as a shared layer covering each of the organic layers 14.

As for the red luminescence element 11R of these organic electroluminescence elements 11R (11), 11G, and 11B, the organic layer 14 provided on the anode 13 has, for example, a hole inject layer 14a, a hole transport layer 14b, a red luminescence layer 14c-R (14c) using a naphthacene derivative for a host material, and an electron transport layer 14d, which are laminated in this order from the anode 13 side.

Also, the organic layer in the green luminescence element 11G has, for example, in the order from the anode 13 side, a hole inject layer 14a, a hole transport layer 14b, a green luminescence layer 14c-G, and an electron transport layer 14d, which are laminated in such an order. Similarly, the organic layer in the blue luminescence element 11B has, for example, in the order from the anode 13 side, a hole inject layer 14a, a hole transport layer 14b, a blue luminescence layer 14c-B, and an electron transport layer 14d, which are laminated in such an order.

Then, a plurality of the organic electroluminescence elements 11R (11), 11G, and 11B provided in the above manner is assumed to be covered with a protection film. Besides, this protection film is assumed to be provided to cover the whole display area for which the organic electroluminescence elements 11R, 11 and 11B are provided.

Here, each of the layers from the anodes 13 to the cathode 15 which configure the red luminescence element 11R (11), the green luminescence element 11G, and the blue luminescence element 11B can be formed by a dry process, such as vacuum evaporation, ion beam (EB), molecular beam epitaxy (MBE), spattering, organic vapour phase deposition (OVPD), and the like.

Also, the organic layers can be formed by, in addition to the above processes, a wet process, for example, coating processes, such as laser transferring, spin coating, dipping, doctor blade process, eject coating, and spray coating, and printing processes, such as ink jet, offset printing, anastatic printing, gravure printing, screen printing, and micro-gravure coating. The dry process and the wet process may be combined, depending on the properties of each organic layer and each member.

Then, the organic layer 14 patterned for each of the organic electroluminescence elements 11R (11), 11G, and 11B in the above manner, is formed by evaporating and transferring with masks, for example.

The so formed display devices can be preferably used for a flat panel display of a wall hanging TV and for a flat illuminator, and can be applied to a light source of a copier, printer, and the like, and to a light source of a liquid-crystal display, meters, and the like, and to a display board, a sign illumination, and the like.

Also, in the above example, the explanation has been done with an active matrix type display in mind, but a display device according to an embodiment of the present invention can be, of course, applied to a passive matrix type display device.

Besides, in each of the organic electroluminescence elements 11R (11), 11G, and 11B, the layers can be shared, except for the luminescence layers 14c. Also, in the green luminescence elements 11G and the blue luminescence elements 11B, electron transport layers 14d made up of different materials may be provided to adapt to respective luminescence layers 14c-G and 14c-B.

### (1) Example of Whole Configuration

When an image in high definition is reproduced by a display device using an organic electroluminescence panel, various adjustments are necessary for video signals. For the adjustments on video signals, there can be given examples, such as adjustment on variation in organic electroluminescence panels, adjustment on luminescence unevenness (uniformity of luminance) on the whole panel, adjustment on local luminescence unevenness, management on temporal changes of white balance and colour temperature, protection from an overflowed current, prevention and reduction of sticking, and the like.

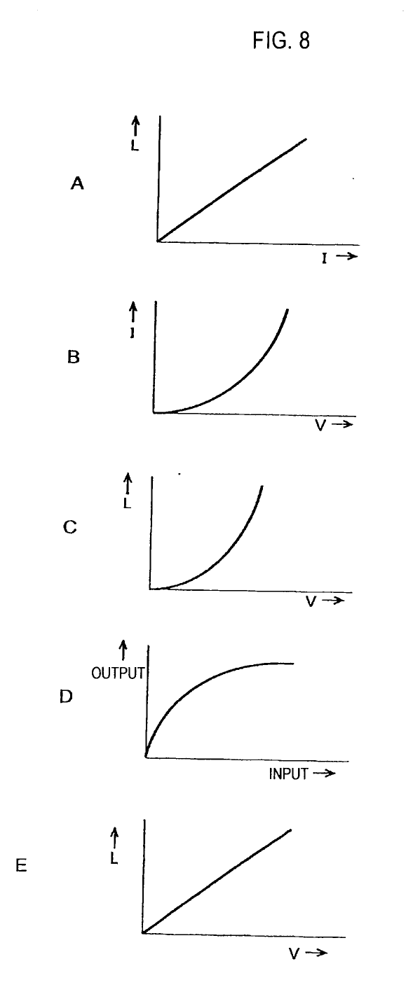

Also, as shown in FIG. 8A, an organic electroluminescence element D has the luminance (light intensity) L in proportion to a signal current I. However, when a signal voltage V is supplied to a transistor Q, the relation between the signal voltage V and the signal current I gets an exponential characteristic due to the characteristic of the transistor Q, as shown in FIG. 8B. As a result, the relation between the signal voltage V and the luminance L of the organic electroluminescence element D gets an exponential characteristic, as shown in FIG. 8C.

Therefore, for the display device using an organic electroluminescence panel, it is necessary to provide a circuit whose input/output characteristic is an exponential characteristic that is complementary to the characteristic of FIG. 8C, as shown in FIG. 8D, and to adjust the level of the signal voltage V of a video signal by this adjusting circuit so that the relation between the signal voltage V (before adjustment) and the luminance L gets linear; namely, for the display device using an organic electroluminescence panel, inverse gamma adjustment is necessary.

Then, it is preferable to set an adjustment value depending on an individual organic electroluminescence panel, because this inverse gamma adjustment varies depending on the variation of the characteristics of the transistors Q. Also, the inverse gamma adjustment may be realised by, for example, adaptively adjusting by the displayed location and the signal level in correspondence to the transistor Q for each pixel, and further, another functional block may be provided for adjusting by the displayed location and the signal level.

On the other hand, when a video signal for TV broadcasting or the like is supplied to a Braun tube, for example, it has been gamma-adjusted so that relation between its signal voltage and luminance gets linear. However, the characteristic of this gamma adjustment for a Braun tube is different from the characteristic (FIG. 8D) of the gamma adjustment that is necessary for an organic electroluminescence element. Therefore, for the display device using an organic electroluminescence panel, it is necessary to consider the difference between the characteristic of the gamma adjustment for a Braun tube and the characteristic of the gamma adjustment for an organic electroluminescence element.

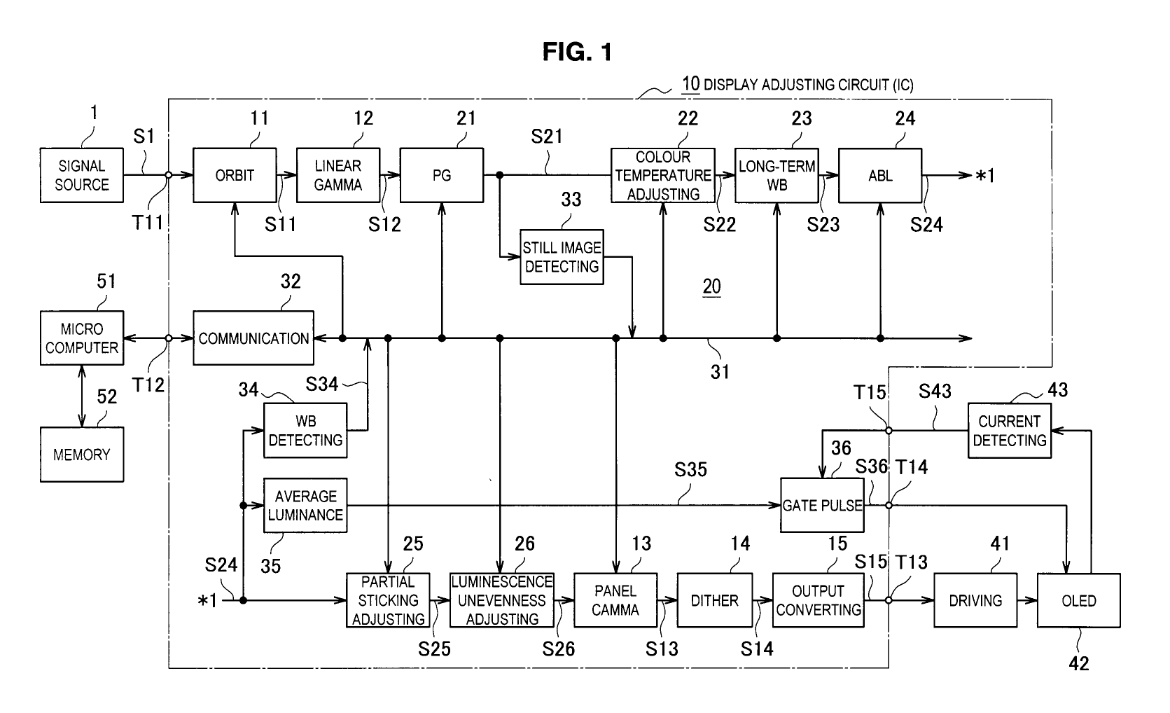

FIG. 1 shows an example of a display adjusting circuit that execute the above-mentioned various adjustments, and its usage example; namely, in FIG. 1, the section 10 enclosed by the dashed line indicates the display adjusting circuit for definition, and this is configured to be, for example, an LSI, or an IC as one-chip IC by FPGA. Then, this IC (display adjusting circuit) 10 has terminal pins T11-T15 for external connection.

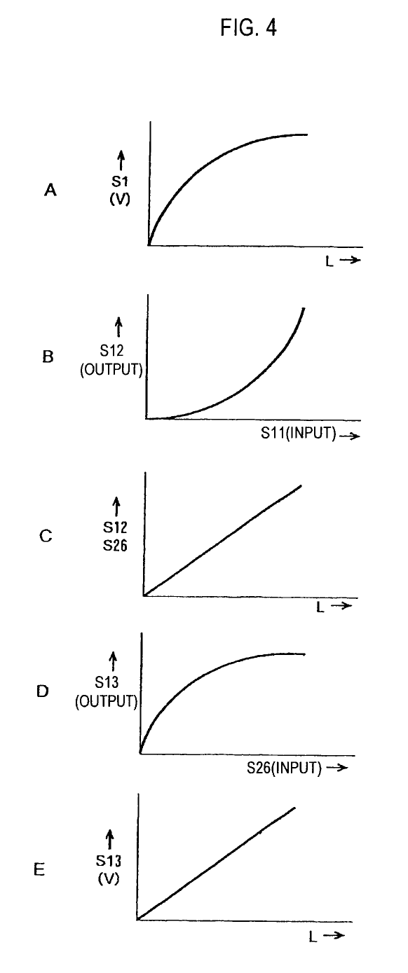

Also, the reference numeral 1 indicates a signal source, such as a tuner circuit or a DVD player, and from this signal source 1, a video signal (a signal of three primary colours: red; green; and blue) S1 is taken. This video signal S1 is a digital signal, and also a signal in a format similar to that of video signals for TV broadcasting. Therefore, as shown in FIG. 4A, the video signal S1 can be approximated to the characteristic as shown by Equation 1 below, for example, by being performed the gamma adjustment for a Braun tube, where, “L” in Equation 1 denotes the luminance of an object, and “V” denotes the signal voltage of the signal S1. Also, “γ1” in Equation 1 denotes a gamma value (e.g., γ1=approximately 2.2), “k1” denotes a constant, and “̂” denotes an operation sign representing an exponential.

L=k1·V̂(1/γ1) (Equation 1)

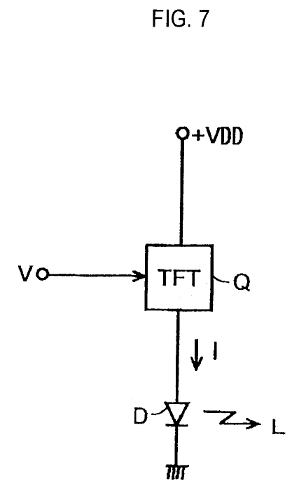

Moreover, the reference numeral 42 indicates an organic electroluminescence panel for image display. The organic electroluminescence panel 42 has a transistor for driving for each organic electroluminescence element, as described with reference to FIG. 7, and also, as shown in FIG. 8C, the luminescence characteristic can be approximated by Equation 2 below, where, “L” in Equation 2 denotes the luminance of the luminance of an organic electroluminescence element, and “V” denotes an input signal voltage. Also, “γ2” in Equation 2 denotes a gamma value, “k2” denotes a constant, and “̂” denotes an operation sign representing an exponential. Besides, the aspect ratio of the organic electroluminescence panel 42 is, for example, 16:9.

L=k2·V̂γ2 (Equation 2)

Also, the reference numeral 51 is a micro computer for control that controls adjustments by this display adjusting circuit 10 automatically or according to instructions from the outside.

Then, the video signal S1 from the signal source 1 is supplied to an orbit circuit 11 through the terminal pin T11 of the IC 10. This orbit circuit 11 is a circuit for periodically deviating up/down and to the right/left the whole image displayed on the organic electroluminescence panel 42 in a slow speed so that viewers will not notice; namely, because of such a configuration, even if a still image or a image in the standard format (4:3) has been displayed to result in sticking, the outline of the sticking will be vague and indistinctive. Thus, from the orbit circuit 11, a video signal S11 is taken out with sticking reduced.

Subsequently, this video signal S11 is supplied to a linear gamma circuit 12 to become a video signal S12. This linear gamma circuit 12 is configured to cancel the gamma characteristic of the video signal S11, so that, as shown in FIG. 2B, it has a complemented input/output characteristic with the gamma characteristic given to the video signal S11. The complemented input/output characteristic is expressed by Equation 3 below, for example, where “k3” in Equation 3 denotes a constant.

S12=k3·S11̂γ1 (Equation 3)

Therefore, from the linear gamma circuit 12, as shown in FIG. 4C, the video signal S12 with characteristic in which the signal voltage V varies linearly to the luminance L of the object is output. Besides, at this point, the video signal S12 is configured to be 14 bits for one sample, for example.

Then, this video signal S12 is supplied to an adjusting circuit 20. This adjusting circuit 20 has circuits 21-26 and executes the above-mentioned various adjustments, controlled by the micro computer 51; the details of this adjusting circuit 20 will be described in (2). Then, the adjusting circuit 20 outputs an adjusted video signal S26. Besides this video signal S26 will be a signal that changes in linear to the luminance L as also shown in FIG. 4C.

Then, this video signal S26 is supplied to a panel gamma circuit 13 to become a video signal S13. This panel gamma circuit 13 is configured to cancel the gamma characteristic of the organic electroluminescence panel 42 by attaching a predetermined gamma characteristic to the video signal S13. Thus, the panel gamma circuit 13 has, as shown in FIG. 4D, a complemented input/output characteristic (equal to the input/output characteristic in FIG. 8D) with the characteristic in FIG. 8C. The complemented input/output characteristic is expressed by Equation 4 below, for example, where “k4” in Equation 4 denotes a constant.

S13=k4·S26̂(1/γ2) (Equation 4)

Therefore, from the panel gamma circuit 13, as shown in FIG. 4E, the video signal 13 with a gamma characteristic in which the relation of the luminance L of the organic electroluminescence panel 42 and the signal voltage becomes a linear relation is output. Besides, at this point, the video signal S13 is configured to be 12 bits for one sample, for example.

This video signal S13 is supplied to a dither circuit 14 to become a video signal S14 on which a dither process is performed by 10 bits for one sample, for example. Also, this video signal S14 is supplied to an output converting circuit 15 to format-converted into a video signal S15 in the RSDS (registered trademark) format from the signal of the three primary colours. Then, this video signal S15 is taken out to the terminal pin for output T13.

The video signal S15 taken out to this terminal pin T13 is supplied to a driving circuit 41 to be D/A-converted from a digital signal to an analogue signal, and then, supplied to the organic electroluminescence panel 42. Therefore, the video signal S1 supplied from the signal source 1 is displayed on the organic electroluminescence panel 42 as a coloured image.

### (2) Configuration Example of Adjusting Circuit 20

The adjusting circuit 20 is configured with detecting units including circuits 33-35 and adjusting units including circuits 21-26, and an adjustment is executed by these adjusting units 21-26 as follows.

Now, the video signal S12 output from the linear gamma circuit 12 is supplied to a pattern generator circuit 21. This pattern generator circuit 21 outputs the supplied video signal S12 directly as a video signal S21 in the case of normal viewing. However, When adjustments, tests, and the like are performed on this organic electroluminescence display device using the display adjusting circuit 10 and the organic electroluminescence panel 42, a video signal for various adjustments or tests which is displayed as a test pattern or a colour bar is formed, and this signal is output as the video signal S21 instead of the video signal S12.

Then, the video signal S21 output from the pattern generator circuit 21 is supplied to a colour temperature adjusting circuit 22 to be converted into a video signal S22 of a colour temperature set by a viewer, and then this video signal S22 is supplied to a long-term white balance adjusting circuit 23. This long-term white balance adjusting circuit 23 is configured to adjust temporal changes in white balance which occur at a long-term use of the organic electroluminescence panel 42, and to output the video signal S23 with its white balance adjusted.

This video signal S23 as a result of the white balance adjustment is supplied to an ABL circuit 24, and from the ABL circuit 24, a video signal S24 with the peak luminance controlled is output. Also, this video signal S24 is supplied to a partial sticking adjusting circuit 25, and the partial sticking circuit 25 detects a partial sticking from a signal level and time. Then, the partial sticking adjusting circuit 25 outputs a video signal S25 which is adjusted based on a detection result.

Then, this video signal S25 is supplied to an adjusting circuit 26 for luminescence unevenness (uniformity of luminance) on the whole screen of the organic electroluminescence panel 42, and adjusted to be a video signal S26 with uniform luminance. Therefore, from the adjusting circuit 20, the video signal S26 in which luminescence unevenness is adjusted by the luminescence unevenness adjusting circuit 26 and also in which various adjustments are performed by the circuits 21-25 is taken out, and this video signal S26 is supplied to the panel gamma circuit 13 as described above.

(3) Details of Control over Adjusting Circuit 20

In order to execute appropriately the above-mentioned adjusting process, a bus line for control 31 is provided for the display adjusting circuit 10, and this bus line 31 is connected to the terminal pin T12 through a communication circuit 32, and also the micro computer for control 51 is connected to this terminal pin T12. Also, a non volatile memory 52 for storing various data, histories, and the like is connected to this micro computer 51.

Then, the video signal S21 (normally a video signal for broadcasting or the like) output from the pattern generator circuit 21 is supplied to a still image detecting circuit 33, it is detected whether an image to be displayed based on the video signal S21 is a still image, and its detection signal S32 is supplied to the micro computer 51 through the communication circuit 32.

Then, in the micro computer 51, a predetermined control signal is formed based on the detection signal S32, and also this control signal is supplied to the orbit circuit 11 through the communication circuit 32. As a result, when an image displayed based on the video signal S21 is a still image, its display location is controlled, and sticking on the organic electroluminescence panel 42 is reduced or gets indistinct. Besides, this process can be realised by, for example, shifting the waveform part which is to be displayed as an image with respect to the perpendicular and horizontal synchronous pulses.

Moreover, the control signal is supplied from the micro computer 51 to the pattern generator circuit 21 through the communication circuit 32, and the pattern generator circuit 21 performs a switching control as follows, for example. Besides, this switching control is performed by, for example, instructing the micro computer 51 by a viewer or a testing operator and an adjusting operator at a manufacturer via a main micro computer (not shown).

Output directly the video signal S12 supplied from the linear gamma circuit 12.

Form a video signal to be displayed as a test pattern or a colour bar and output it.

Form a video signal at a constant level so that the whole screen has a uniform luminance, and output it.

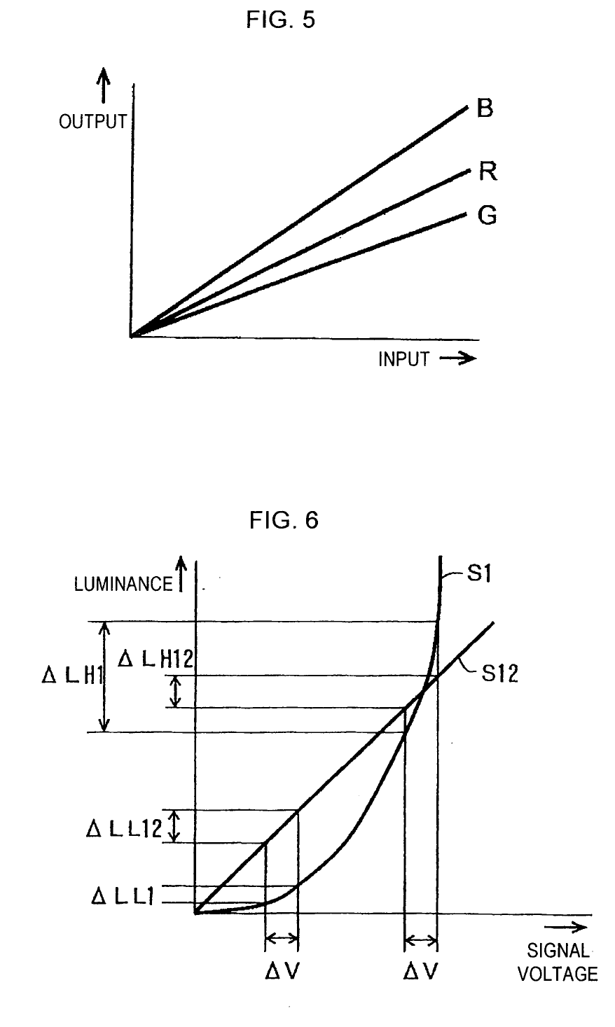

Also, for example, if a viewer or a testing operator and an adjusting operator at a manufacturer instruct the micro computer 51 on adjusting and setting colour temperature via the main micro computer, this is informed to the colour temperature adjusting circuit 22 from the micro computer 51 through the communication circuit 32, and the colour temperature is adjusted and set to a target characteristic. Besides, this adjustment and setting of colour temperature are performed by, for example, adjusting and setting the slope of the input/output characteristic in FIG. 5 with respect to each of the three primary colour signals R-B.

Moreover, in order to adjust temporal changes in white balance, the video signal S24 output from the ABL circuit 24 is supplied to a white balance detecting circuit 34, and a detection signal S34 that indicates each level for each colour signal of the video signal (three primary colours signal) S24 is taken out. Then, this detection signal S34 is supplied to the micro computer 51 through the communication circuit 32.

In this case, the detection signal S34 indicates the level of each colour signal, and accordingly, it is a signal that indicates the luminance of each colour of the organic electroluminescence panel 42. Then, in the micro computer 51, the detection signal S34 for each of the colours is accumulated, and the accumulated luminescence amount (luminance×time) for each colour of the organic electroluminescence panel 42 is calculated.

Here, if the accumulated luminescence amount is large, it means that the luminance of the organic electroluminescence 42 is lowered correspondingly; namely, the accumulated luminescence amount will also correspond to the degradation amount of the luminance for each colour of the organic electroluminescence panel 42. Hence, the micro computer 51 can derive an adjustment value for each colour, based on a calculated value for the accumulated luminescence amount, by, for example, referring to a table which is prepared in advance in the memory 52 to show luminance degradation of each colour with respect to the accumulated luminescence amount. Then, this adjustment value is supplied to the long-term white balance adjusting circuit 23 through the communication circuit 32, the slope of the input/output characteristic in FIG. 5 is altered, and a temporal change in white balance is adjusted, for example.

Thus, information corresponding to the driving state of the organic electroluminescence panel 42 is detected by converting the gamma characteristic of an input signal into a video signal with a linear input/output characteristic, and based on the signal information with the input/output characteristic converted into linear, deriving an accumulated value of luminescence amount via a simple adding process. Then, the table prepared in the memory 52 is read out by use of the detection result, so that a video signal to be output is adjusted via a simple operation for altering the slope of the input/output characteristic.

And then, an adjustment on the video signal is configured to be performed according to the gamma characteristic of the organic electroluminescence panel 42, and light L at the luminance (light intensity) which is in proportion to the size of a driving current I is output (light output for the driving current has a linear characteristic). Therefore, a value for signal information with the input/output characteristic converted into linear corresponds to light output of an element of the organic electroluminescence panel 42, namely to the driving state of the element.

Thus, the driving state of the organic electroluminescence panel is detected readily from the signal information with the input/output characteristic converted into linear, and because the driving history can be further detected based on the driving state, a proper adjustment on a video signal can be performed by relatively small sized circuitry configuration by use of the detection result. Therefore, an image display in high definition is held on the organic electroluminescence panel 42.

Also, the video signal S24 output from the ABL circuit 24 is supplied to an average luminance detecting circuit 35, and from a rate of voltage of each colour signal in the video signal S24, an average luminance for one frame period, for example. Then, this detection signal S35 is supplied as a control signal to a gate pulse circuit 36. This gate pulse circuit 36 is configured to control a duty ratio of the luminescence period of the organic electroluminescence panel 42, namely a rate of the luminescence period of the organic electroluminescence panel 42 for one frame period.

Thus, from the gate pulse circuit 36, a control signal S36 is output for controlling a duty ratio of the luminescence period in the frame next to the frame for which a duty ratio of the luminescence period of the organic electroluminescence panel 42 is calculated. Then, this control signal S36 is supplied as a control signal for the duty ratio of the luminescence period to the organic electroluminescence panel 42 through the terminal pin T14, and the organic electroluminescence panel 42 is protected.

Also, at this point, the magnitude of the signal current I flowing to the organic electroluminescence panel 42 is detected by a current detecting circuit 43, and a detection signal S43 of this is supplied to the gate pulse circuit 36 through the terminal pin T15. Then, the control signal S36 is controlled based on a result of detecting the signal current I flowing to the organic electroluminescence panel 42, and if the magnitude of the signal current changes sharply by the frame next to the frame for which the signal current I flowing to the organic electroluminescence panel 42 is detected, the current amount to be supplied to the organic electroluminescence panel 42 is controlled. Therefore, the organic electroluminescence panel 42 is protected from an overflowed signal current I.

Even in this case, between the linear gamma circuit 12 and the panel gamma circuit 13, an average luminance can be detected by deriving the sum of values of image data for one frame by use of signal information with the input/output characteristic converted into linear. Here, because the above average luminance corresponds to the total current amount to be supplied to the whole organic electroluminescence panel 42, control for protecting the organic electroluminescence panel 42 is realised via a simple signal process by four arithmetic operations.

Moreover, in the luminescence unevenness adjusting circuit 26, adjustment on luminescence unevenness on the whole screen of the organic electroluminescence panel 42 is performed. This adjustment is performed at the time of alignment, testing, and the like. Now, the video signal S12 at a uniform level is output from the pattern generator 21, and therefore, the whole screen of the panel 42 emits light at a uniform luminance if there is no luminescence unevenness on the organic electroluminescence panel 42.

Then, the whole screen of this organic electroluminescence panel 42 is captured by an imaging element, such as a video camera, and luminescence unevenness of the panel 42 is detected. Besides, this detection is performed for each luminescence colour of red, blue, and green, for example. Then, this detection result is supplied to the micro computer 51, an adjustment value is calculated by referring to the table with reference to the level of the video signal S25 and the coordinate location (scanning location) on the organic electroluminescence panel 42, and this adjustment value is supplied to the luminescence unevenness adjusting circuit 26 through the communication circuit 32, so that luminescence unevenness is adjusted.

Thus, in the adjusting circuit 20, various adjustments are performed, such as adjustment on colour temperature, adjustment on temporal changes in white balance, adjustment on sticking and luminescence unevenness of the organic electroluminescence panel 42, and control over the maximum luminance, etc., so that an image as a result of executing them is displayed on the organic electroluminescence panel 42.

### (4) Conclusion

According to the above-mentioned display adjusting circuit 10, various adjustments for the organic electroluminescence panel 42 are configured to be performed by the adjusting circuit 20 configured with the detecting units including the circuit 33-35 and the adjusting units including the circuit 21-26, so that an image in high definition can be achieved. Then, if the adjusting circuit 20 performs adjustment, the adjustment can be performed certainly by simple configuration, because the video signal S1 with the gamma characteristic for a Braun tube is made to be the video signal S13 with a linear gamma characteristic as shown in FIG. 4E by the linear circuit 12 and various adjustments and level detections which are necessary for the adjustments are performed on this video signal S13.

Now, because the input video signal S1 has a gamma characteristic as shown in FIG. 6, when adjustment is performed on this video signal S1 (or the video signal S11), even if the voltage variation range ΔV in the case where its voltage level is low and the voltage variation range ΔV in the case of high are equal, the luminance variation range ΔLL1 for the variation range ΔV in the case where voltage level is low and the luminance variation range ΔLH1 for the variation range ΔV in the case of high get different.

In other words, adjustment sensitivities (ΔLL1/ΔV, ΔLH1/ΔV) get different depending on the voltage level of the video signal S1. Therefore, if various adjustments are done as described above, corresponding to the level of the video signal S1, the control range (ΔV) of its adjustment is necessarily changed, the configuration of the adjusting circuit 10 may become complicated, and also the adjustments may be not put into an optimal value.

However, in the described display adjusting circuit 10, the input video signal S1 is made to be the video signal S12 with a linear characteristic as shown in FIG. 4C by the linear gamma circuit 12, and adjustment is configured to be performed on this video signal S12 (or signal S21-S25). Therefore, for the display adjustment circuit 10, as shown in FIG. 6, the luminance variation range ΔLL12 for the variation range ΔV in the case where the voltage level of the video signal S12 is low and the luminance variation range ΔLH12 for the variation range ΔV in the case of high get equal.

In other words, adjustment sensitivities (ΔLL12/ΔV, ΔLH12/ΔV) get equal, regardless of the voltage level of the video signal S12. Therefore, in the adjusting circuit 20, if various adjustments are done as described above, the video signal S12 can be appropriately adjusted, and also the configuration for that gets simple.

Furthermore, on the video signal S12 (S21-S25) which is made to have a linear gamma characteristic as shown in FIG. 4C by the linear gamma circuit 12, gamma adjustment for the organic electroluminescence panel 42 is now done by the panel gamma circuit 13, so that gamma adjustment can be performed properly on the organic electroluminescence panel with a different gamma characteristic, and an image in high definition can be achieved.

Also, when the detecting circuit 33-35 perform various detections, because a video signal has a linear characteristic, the detection sensitivities for the video signal get equal, regardless of the level of the video signal, therefore, detection in high precision can be done, and as a result, high definition can be achieved.

### (5) Notes

In the above, if the same gamma characteristic as those of the video signal S1 are given to a test video signal to be output from the pattern generator 21, then the pattern generator 21 can come before the linear gamma circuit 12.

### LIST OF ABBREVIATIONS

ABL: Automatic Brightness Limiter

EL: ElectroLuminescence

FPGA: Field Programble Gate Array

IC: Integrated Circuit

LED: Light Emitting Diode

LSI: Large Scale Integration

OLED: Organic Light Emitting Diode

RSDS: Reduced Swing Differential Signalling (registered trademark)

TFT: Thin Film Transistor

1. A display adjusting circuit for performing adjustment for display on a video signal to be supplied to an organic electroluminescence panel, the display adjusting circuit of the organic electroluminescence panel, comprising:
a linear gamma circuit where a video signal on which a predetermined gamma adjustment has been performed is supplied to be converted into a video signal with a linear gamma characteristic by cancelling the gamma adjustment of the supplied video signal and to be output;
an adjusting circuit to which the video signal output from the linear gamma circuit is supplied; and
a panel gamma circuit where the video signal output from the adjusting circuit is supplied to be converted into a video signal with a gamma characteristic corresponding to a gamma characteristic of the organic electroluminescence panel and to be output,
wherein the adjusting circuit includes
a detecting unit for detecting a driving state or a driving history of the organic electroluminescence panel from the supplied video signal,
an adjusting unit for performing adjustment on the video signal supplied to the organic electroluminescence panel by a detecting output of the detecting unit.

2. The display adjusting circuit of the organic electroluminescence panel, according to claim 1,
wherein the detecting unit detects a luminescence amount of the organic electroluminescence from a signal level of the video signal, and
wherein the adjusting unit controls a level of a video signal to be output from the adjusting circuit, according to a detection output of the luminescence amount.

3. The display adjusting circuit of the organic electroluminescence panel, according to claim 1,
wherein the detecting unit detects an average luminance for each one frame of the organic electroluminescence from a signal level of the video signal, and
wherein the adjusting unit controls a level of a video signal to be output from the adjusting circuit in a frame next to a frame for which the average luminance is detected, according to a detection output of the average luminance.

4. The display adjusting circuit of the organic electroluminescence panel, according to claim 1,
wherein the detecting unit detects an accumulated luminescence amount of the organic electroluminescence from a signal level of the video signal, and
wherein the adjusting unit adjusts a video signal to be output from the adjusting circuit, according to a detecting output of the luminescence amount.

5. The display adjusting circuit of the organic electroluminescence panel, according to claim 4, wherein the adjusting circuit adjusts white balance of a video signal.

6. The display adjusting circuit of the organic electroluminescence panel, according to claim 4, the display adjusting circuit further comprising:
a memory in which data that indicates luminescence degradation for an accumulated luminescence amount is stored; and
a micro computer connected to the memory,
wherein a video signal is adjusted by referring to the accumulated luminescence amount detected by the detecting unit and the data stored in the memory.

7. A display adjusting circuit for performing adjustment for display on a video signal to be supplied to a display device, the display adjusting circuit comprising:
a linear gamma circuit where a video signal on which a predetermined gamma adjustment has been performed is supplied to be converted into a video signal with a linear gamma characteristic by cancelling the gamma adjustment of the supplied video signal and to be output;
an adjusting circuit to which the video signal output from the linear gamma circuit is supplied; and
a panel gamma circuit where the video signal output from the adjusting circuit is supplied to be converted into a video signal with a gamma characteristic corresponding to a gamma characteristic of the display device and to be output,
wherein the adjusting circuit includes
a detecting unit for detecting a driving state or a driving history of the display device from the supplied video signal,
an adjusting unit for performing adjustment on the video signal supplied to the display device by a detecting output of the detecting unit.

8. The display adjusting circuit according to claim 7,
wherein the detecting unit detects a luminescence amount of the display device from a signal level of the video signal, and
wherein the adjusting unit controls a level of a video signal to be output from the adjusting circuit, according to a detection output of the luminescence amount.

9. The display adjusting circuit according to claim 7,
wherein the detecting unit detects an average luminance for each one frame of the display device from a signal level of the video signal, and
wherein the adjusting unit controls a level of a video signal to be output from the adjusting circuit in a frame next to a frame for which the average luminance is detected, according to a detection output of the average luminance.

10. The display adjusting circuit according to claim 7,
wherein the detecting unit detects an accumulated luminescence amount of the display device from a signal level of the video signal, and
wherein the adjusting unit adjusts a video signal to be output from the adjusting circuit, according to a detecting output of the luminescence amount.

11. The display adjusting circuit according to claim 10, wherein the adjusting circuit adjusts white balance of a video signal.

12. The display adjusting circuit according to claim 10, the display adjusting circuit further comprising:
a memory in which data that indicates luminescence degradation for an accumulated luminescence amount is stored; and
a micro computer connected to the memory,
wherein a video signal is adjusted by referring to the accumulated luminescence amount detected by the detecting unit and the data stored in the memory.

13. A display device with an organic layer, the display device comprising:
an organic electroluminescence panel including an organic electroluminescence element and a driving transistor for each pixel;
a display adjusting circuit for performing adjustment for display on a video signal to be supplied to the display device;
a linear gamma circuit where a video signal on which a predetermined gamma adjustment has been performed is supplied to be converted into a video signal with a linear gamma characteristic by cancelling the gamma adjustment of the supplied video signal and to be output;
an adjusting circuit to which the video signal output from the linear gamma circuit is supplied; and
a panel gamma circuit where the video signal output from the adjusting circuit is supplied to be converted into a video signal with a gamma characteristic corresponding to a gamma characteristic of the organic electroluminescence panel and to be output,
wherein the adjusting circuit includes
a detecting unit for detecting a driving state or a driving history of the organic electroluminescence panel from the supplied video signal,
an adjusting unit for performing adjustment on the video signal supplied to the organic electroluminescence panel by a detecting output of the detecting unit.

14. The display device according to claim 13,
wherein the detecting unit detects a luminescence amount of the organic electroluminescence panel from a signal level of the video signal, and
wherein the adjusting unit controls a level of a video signal to be output from the adjusting circuit, according to a detection output of the luminescence amount.

15. The display device according to claim 13,
wherein the detecting unit detects an average luminance for each one frame of the organic electroluminescence from a signal level of the video signal, and wherein the adjusting unit controls a level of a video signal to be output from the adjusting circuit in a frame next to a frame for which the average luminance is detected, according to a detection output of the average luminance.

16. The display device according to claim 13,
wherein the detecting unit detects an accumulated luminescence amount of the organic electroluminescence from a signal level of the video signal, and
wherein the adjusting unit adjusts a video signal to be output from the adjusting circuit, according to a detecting output of the luminescence amount.

17. The display device according to claim 16, wherein the adjusting circuit adjusts white balance of a video signal.

18. The display device according to claim 16, the display adjusting circuit further comprising:
a memory in which data that indicates luminescence degradation for an accumulated luminescence amount is stored; and
a micro computer connected to the memory,
wherein a video signal is adjusted by referring to the accumulated luminescence amount detected by the detecting unit and the data stored in the memory.

19. The display device according to claim 13, comprising:
a writing transistor connected to the driving transistor Tr1; and
a hold capacitance connected to the writing transistor and the driving transistor.
